(19) United States
(12) Patent Application Publication
(10) Pub. No.: US 2026/0240242 A1
(43) Pub. Date: Aug. 20, 2026

(54) AEROSOL-GENERATING DEVICE COMPRISING A RESONATOR WITH A TRANSMISSION LINE

(71) Applicant: Philip Morris Products S.A., Neuchatel (CH)

(72) Inventors: Ralf DUMLER, Monthey (CH); Alberto TORREÑO NÚÑEZ, Lustenau (AT)

(73) Assignee: Philip Morris Products S.A., Neuchatel (CH)

(21) Appl. No.: 19/489,502

(22) PCT Filed: Jun. 13, 2024
(86) PCT No.: PCT/EP2024/066489

§ 371 Date: Dec. 2, 2025

(30) Foreign Application Priority Data
Jun. 13, 2023 (EP) 23178984.3

(51) Int. Cl. A24F 40/465; A24F 40/20

(52) U.S. Cl. CPC A24F 40/465; A24F 40/20

(57) ABSTRACT

An aerosol-generating device configured to generate aerosol by heating an aerosol-generating material, the aerosol-generating device including: a cavity to receive the aerosol-generating material; an electromagnetic field generator to generate a signal; and a resonator disposed in the cavity and electrically connected, via at least one feed, to the generator, the resonator including: first and second transmission lines to receive the generated signal and to generate an electromagnetic field configured to heat the aerosol-generating material, and a resonator casing that at least partially surrounds the first and the second transmission lines, each of the first and the second transmission lines including a first portion and a second portion, a distance between the second portions of the first and the second transmission lines being narrower than a distance between the first portions of the first and the second transmission lines, the at least one feed being arranged at the first portion.

### DESCRIPTION

The present invention concerns an aerosol-generating device which is in particular configured to generate aerosol by heating an aerosol-generating material.

Aerosol-generating devices, for instance E-cigarettes or heat-not-burn-devices and the like, are known. These are configured to heat a sample in the form of a fluid or solid in order to release an aerosol, which is then inhaled by a consumer.

Such devices are known from for example WO2022/128290 A1 or WO2021/013477 A1, the latter of which discloses an aerosol-generating device for heating an aerosol-forming substrate, e.g., a tobacco plug, to generate an aerosol. The device comprises a substrate cavity configured to receive an aerosol-forming substrate and an electromagnetic field generator configured to generate a radio frequency (RF) electromagnetic field in the substrate cavity.

One problem associated with prior known aerosol-generating devices is that these non-uniformly heat the aerosol-generating sample/substrate. Further, in prior known RF electromagnetic field employing devices, a field distribution thereof is non-uniform such that the efficiency and thoroughness with which the aerosol-generating devices heat the sample, e.g., the tobacco plug, is low. Low overall efficiency is especially disadvantageous in handheld devices due to battery capacity restrictions.

It is an object of the present invention to provide an aerosol-generating device which overcomes one or more of these deficiencies. In particular, it is an object of the present invention to provide an aerosol-generating device which is configured to uniformly heat an aerosol-generating material with improved efficiency.

This object is achieved by the features of the independent claim. The dependent claims contain advantageous embodiments of the present invention.

In particular, this object is achieved by an aerosol-generating device according to claim 1. The aerosol-generating device is configured to generate an aerosol by heating an aerosol-generating material, especially a nicotine containing aerosol generating material such as a tobacco-containing material, especially reconstituted tobacco. Therein, the aerosol-generating device comprises a cavity configured to receive the aerosol-generating material, an electromagnetic field generating unit configured to generate a signal, and a resonator. The resonator is disposed in the cavity of the device and is electrically connected, via at least one feed, to the electromagnetic field generating unit. Therein, the resonator comprises at least one transmission line configured to receive the signal generated by the electromagnetic field generating unit. The at least one transmission line is further configured to generate an electromagnetic field for heating the aerosol-generating material. Further, the resonator comprises a resonator casing which at least partially surrounds the at least one transmission line. Therein, the at least one transmission line is disposed around the received aerosol-generating material such that the generated electromagnetic field propagates through the received aerosol-generating material into another portion of the at least one transmission line. For example, as also described later in the different embodiments and examples, the at least one transmission line is (or are) disposed around the received aerosol-generating material and includes a first portion (of the least one transmission line) emitting the generated electromagnetic field through the received aerosol generating material into a second portion (of the same or of a different of the at least one transmission line) receiving the generated electromagnetic field. In other words, the at least one transmission line is disposed around the received aerosol-generating material and includes a first portion and a second portion configured to allow propagation of the electromagnetic field through the aerosol generating material. As the skilled person understands, emitting an electromagnetic field and receiving an electromagnetic field refers to a representation (e.g., in the form of vector(s), a diagram showing the field lines, etc.) of the electromagnetic field propagating from a first portion to a second portion while it propagates through the aerosol generating material. As later described in embodiments and examples, disposed around the aerosol generating material preferably includes disposed in close proximity of and/or at least partially in contact with the aerosol generating material.

The arrangement of the at least one transmission line and the cavity as defined above ensures that the at least one transmission line is disposed around the aerosol-generating material when it is received in the cavity. As such, as will be described in more detail below, it is possible to provide a uniform field distribution in the cavity such that a uniform field distribution may be provided in the received aerosol-generating material as the generated electromagnetic field propagates from one portion of the at least one transmission line through the received aerosol-generating material and into another portion of the at least one transmission line. This in turn allows the received aerosol-generating material to be uniformly heated, thereby improving heating efficiency. The aerosol-generating material (henceforth: “the material”) is a label used to mean a medium that generates an aerosol or vapour when heated. It may be synonymous with vapour precursor material, aerosol generation or generating medium, substrate or material. Aerosol generating material includes liquid or solid materials that provide volatilized components upon heating, typically in the form of vapour or an aerosol. Aerosol generating material may be a non-tobacco-containing material or a tobacco-containing material. Aerosol generating material may, for example, include one or more of tobacco per se, tobacco derivatives, expanded tobacco, reconstituted tobacco, tobacco extract, homogenized tobacco or tobacco substitutes. Aerosol precursor material also may include other, non-tobacco, products, which, depending on the product, may or may not contain nicotine. Aerosol generating material may comprise one or more humectants, such as glycerol or propylene glycol. As anticipated and as will be described in detail in relation to the figures herein, throughout the present application, the term “disposed around” implies for example that the at least one transmission line is in close proximity to the material and preferably wraps around at least part of the material, further preferably is at least partially in contact with the material. In general, respective portions of the at least one transmission line may be disposed at opposing sides or surfaces of the material so that the generated electromagnetic field may propagate from one portion of the at least one transmission line through the received material and into another portion of the at least one transmission line. Preferably, the portions of the at least one transmission line positioned on opposing sides of the material may be at least partially parallel with respect to a longitudinal axis of the resonator to improve the uniformity of the distribution of the electromagnetic field therebetween. More preferably, the portions of the at least one transmission line may be positioned in the cavity such that their respective faces having a largest surface area are opposed. In particular, the term “in close proximity” may in certain embodiments imply that the at least one transmission line is at least partially disposed around and spaced apart from the material, especially with no other elements therebetween, wherein the space apart is preferably as small as possible for the material to be wrapped around by the at least one transmission line preferably without the material entering into (preferably substantial) contact with the at least one transmission line. Further, the term “close” with regard to “close proximity” especially refers to a spacing between the at least one transmission line and the material, which—as above said—is as small as possible so that the at least one transmission line wraps around the material without the at least one transmission line entering into substantial contact with the material. In some examples, the spacing implied by “close” comprises no more than for example 50%, further preferably 33% (for example ⅔), or further preferably 25% or further preferably 10% of a total width of the material (in a cross section perpendicular to the longitudinal/elongated dimension of the material; for example, the diameter when the cross section is circular) between the portions of the at least one transmission line disposed around it. In some cases also combinable with the above, the at least one transmission line may be at least partially in contact with the material (i.e. only part of the material is in contact, or its lateral surface is substantially entirely in contact). Thus, in case the at least one transmission line is partially in contact with the material, the part that is not in contact may be in close proximity as explained above. Preferably, as it will be discussed in some examples below, the at least one transmission line is in contact with the received material at an upper portion of the at least one transmission line (upper refers to the portion that is closer to the mouth of the user) and is in close proximity (spaced apart, as above explained) therefrom at the lower portion of the at least one transmission line. When reference is made to “in contact”, account may be taken of manufacturing tolerances of the material and/or at least one transmission line causing a spacing therebetween (as well as tolerances in the engagement between material and the at least one transmission line), especially with regard to at least one specific portion of the at least one transmission line. Furthermore, in some embodiments, the term “at least partially in contact” refers for example to the at least one transmission line being at least partially in direct contact with the material. The contact may, in some examples, hold or enable holding of the material by means of the least one transmission line.

In some embodiments, the at least one transmission line may be at least one elongated strip or plate shaped or a wire with, e.g., a rectangular cross section. For example, a single elongated strip bent to form two transmission lines, or two plate shaped strips positioned to oppose one another in the cavity. The at least one transmission line may comprise an electrically conductive material. For example, the at least one transmission line may comprise or consist of a material suitable for carrying, especially transmitting and receiving, the signals described in the examples and embodiments below with particularly low losses. Such examples include gold, copper, and brass, as well as combinations thereof.

In some embodiments, the signal generated by the electromagnetic field generating unit is a radio frequency (RF) signal. In particular, the signal is an RF signal suitable for generating an electromagnetic field that is suitable for heating the material.

Preferably, a frequency of the generated electromagnetic field is a microwave frequency suitable for heating the material. For instance, the microwave frequency may be 500 MHz (0.5 GHZ) or more, for instance 900 MHz. The frequency of the generated electromagnetic field may be between 2000 MHz and 3000 MHz, particularly between 2400 MHz and 2500 MHz, the latter of which advantageously fulfil the regulations of an ISM band of type B.

Preferably, the at least one transmission line emits the electromagnetic field into the material. In the possible case of one transmission line, the electromagnetic field is emitted (through the material) into another portion of the transmission line and preferably also to other components/portions of the resonator, especially into the resonator casing. This has the advantage that an aerosol-generating device with a compact size can be achieved thereby. In the alternative case of more than one transmission line, the electromagnetic field is emitted into the at least one other transmission line and/or another portion of the same transmission line and preferably also into other components/portions of the resonator, especially into the resonator casing. This has the advantage that the aerosol-generating device can be provided with a wider range of connection schemes for the multiple transmission lines.

In one advantageous embodiment, the resonator comprises two transmission lines, namely a first transmission line and a second transmission line.

Preferably, the first transmission line is electrically connected to a signal line of a first feed of said at least one feed. Therein, the second transmission line is electrically connected to a signal line of a second feed of said at least one feed. The signal line of the first feed supplies the generated signal to the first transmission line. The signal line of the second feed supplies a negative generated signal, which is the generated signal phase-shifted by 180°, to the second transmission line.

In one embodiment, the generated signal and the negative generated signal are generated by one single aforementioned electromagnetic field generating unit and are output at respective outputs thereof. This has the advantage of providing a simple and energy-efficient configuration for generating the electromagnetic field. Alternatively, a phase shift circuit comprising active and/or passive electronic or optical components is disposed at least electrically between an output of the electromagnetic field generating unit outputting the generated signal and the second transmission line

Preferably, the generated signal and the negative generated signal are generated by different, respective electromagnetic field generating units. In other words, the aerosol-generating device preferably comprises two electromagnetic field generating units. Thereby, heating power of the aerosol-generating device can be advantageously increased.

In some preferable embodiments, the at least one feed comprises one single feed. Therein, the first transmission line and the second transmission line are electrically connected to the single feed. The first transmission line is connected to a signal line of the single feed and receives the generated signal. The second transmission line is connected to a ground of the single feed. Thereby, a connection scheme of the transmission lines with the electromagnetic field generating unit is advantageously simplified.

In some embodiments, the first transmission line and the second transmission line each comprise a length of one-quarter or one-half of a wavelength of the generated signal. Preferably, both transmission lines comprise the same length (one-half or one-quarter wavelength) or comprise different lengths.

Preferably, the first transmission line and the second transmission line each comprise a length of one-half wavelength. Therein, the first transmission line and the second transmission line are electrically connected to the resonator casing.

In one advantageous embodiment, the at least one feed comprises one single feed and the resonator comprises one transmission line, wherein the resonator casing is electrically connected to a ground of the single feed. Preferably therein, the entire aerosol-generating device comprises exactly one transmission line. Further preferably therein, the entire aerosol-generating device comprises exactly one feed.

Preferably, the transmission line is electrically connected to a signal line of the single feed and electrically receives the generated signal therefrom.

Preferably, the transmission line is asymmetric with respect to a connection point of the transmission line to the signal line. Preferably, the transmission line is asymmetric with respect to a longitudinal axis of the resonator. Preferably therein, a first length of the transmission line from the connection point to one end of the transmission line is not equal to a second length from the connection point to the other end of the transmission line.

Preferably, in the case of the transmission line receiving the generated signal from the signal line, one end of the transmission line is electrically connected to the resonator casing.

In one advantageous embodiment, the resonator casing is, in addition to being connected to a ground of the single feed, further electrically connected to a signal line of the single feed. Therein, the resonator casing receives the generated signal from the signal line and is configured to induce, in the transmission line, a current corresponding to the generated signal. In particular, the current in the transmission line is induced via induction by the resonator casing, which is connected to ground and signal line of the single feed, thereby forming a shorted loop.

In some embodiments, the transmission line comprises, in an upper portion thereof, at least one folded portion. Preferably, a folded portion refers to a portion of the transmission line including a bend of between 30° and 105°, further preferably at least 45°, more preferably at least 90°. Further preferably, a folded portion may comprise multiple bends adjacent to one another, each preferably within the aforementioned ranges. For example, a folded portion may comprise two bends of each 90°. Preferably, the term “adjacent to one another” refers to these being respectively disposed within for example 10% of a total length of the transmission line. Further preferably “upper portion” refers to a portion of the transmission line in an upper half, with respect to the substantial elongation of the aerosol-generating device, of the resonator. The substantial elongation of the aerosol-generating device is preferably defined as a length of the aerosol-generating device along its longitudinal or longest axis. Preferably, the transmission line comprises at least one such folded portion in a correspondingly defined lower portion thereof.

Preferably, the resonator casing is symmetrical with respect to a connection point of the transmission line. Preferably therein, the transmission line and the connection point thereof are disposed within the resonator casing such that the connection point is in a middle thereof, particular a width-wise middle thereof, a width of the resonator casing being perpendicular to the substantial elongation of the aerosol-generating device. Preferably, the resonator casing is axial-symmetric with regard to the connection point, especially an elongation of the feed from the connection point. Preferably, the resonator casing is axial-symmetric with regard to the longitudinal axis of the resonator.

In one advantageous embodiment, the resonator casing contains an opening configured to receive the material. Therein, the at least one transmission line is configured to accommodate the material. Preferably, the at least one transmission line is configured to hold the material via frictional engagement.

Preferably, the at least one transmission line is formed, especially via folded portions, in a shape configured to accommodate the material. Therein, the at least one transmission line is preferably shaped so as to define an inner portion configured to accommodate, especially frictionally engage (i.e., sandwich), the material.

Preferably, in the case of multiple transmission lines, only one, multiple, or all transmission lines are configured to accommodate, especially frictionally engage, the material. For instance, one or more transmission lines are configured to accommodate the material, wherein one or more further transmission lines are configured to (only) emit an electric field.

Preferably, the at least one feed is respectively a coaxial cable comprising at least one signal line and comprising a grounded shielding as ground of the at least one feed.

Preferably, the aerosol-generating device is a handheld device.

Further details, advantages, and features of the preferred embodiments of the present invention are described in detail with reference to the figures. Therein:

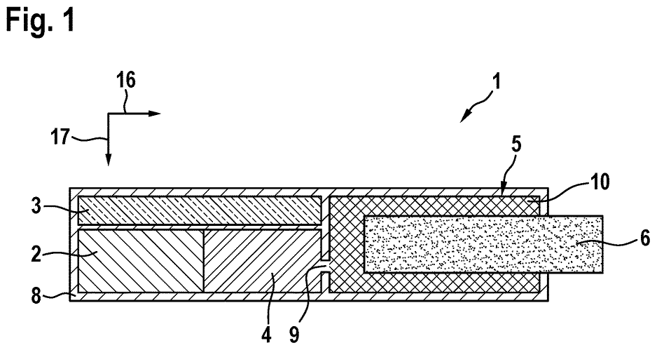

FIG. 1 shows a schematic cross sectional view of an aerosol-generating device according to a first embodiment of the present invention,

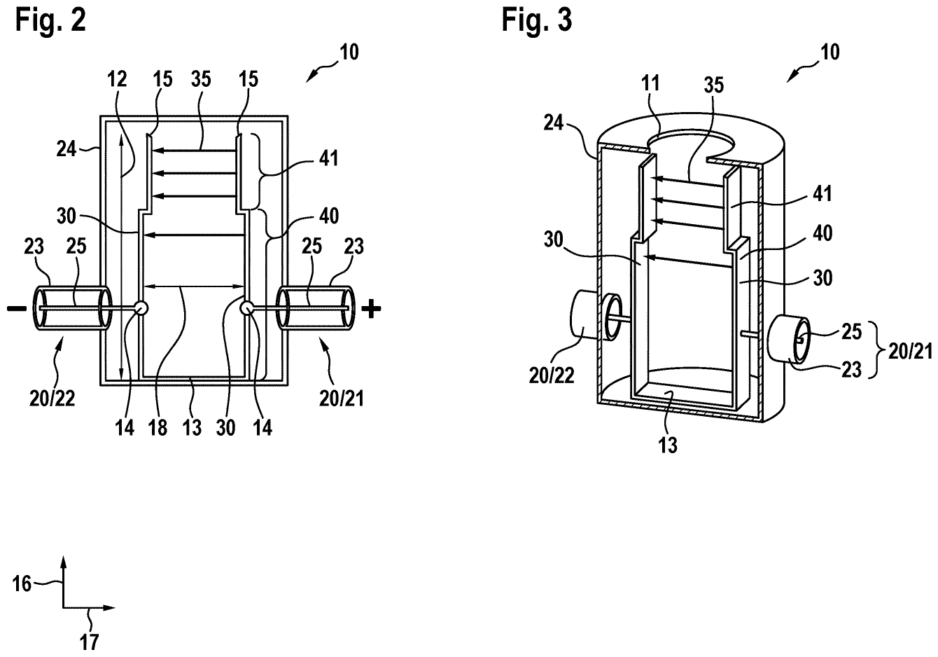

FIG. 2 shows a schematic cross sectional view and 3D model of a resonator in a cavity of an aerosol-generating device according to a second embodiment of the present invention,

FIG. 3 shows a further schematic cross sectional view and 3D model of the resonator in the cavity of the aerosol-generating device according to the second embodiment of the present invention,

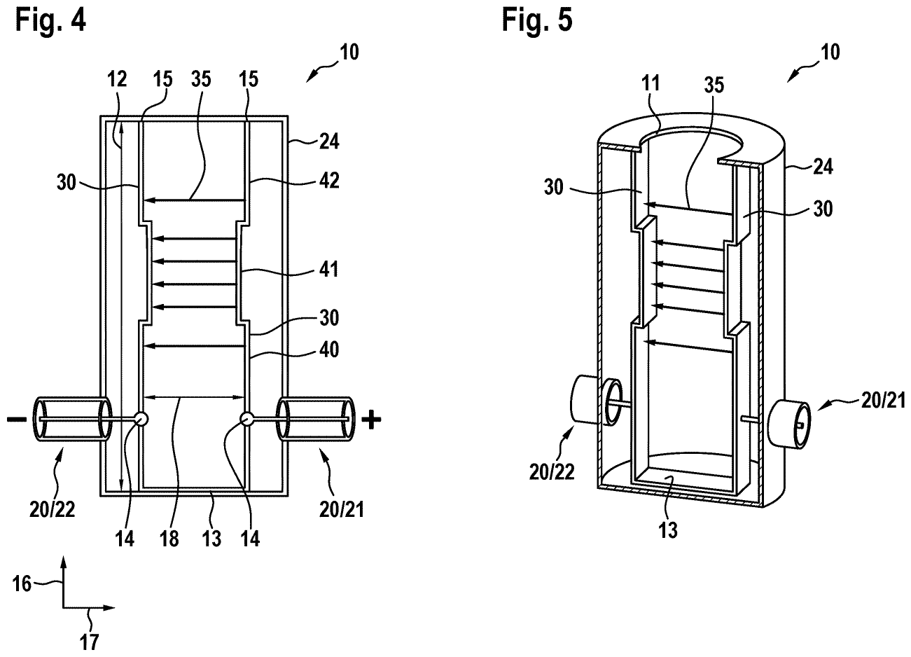

FIG. 4 shows a schematic cross sectional view and 3D model of a resonator in a cavity of an aerosol-generating device according to a third embodiment of the present invention,

FIG. 5 shows a further schematic cross sectional view and 3D model of the resonator in the cavity of the aerosol-generating device according to the third embodiment of the present invention,

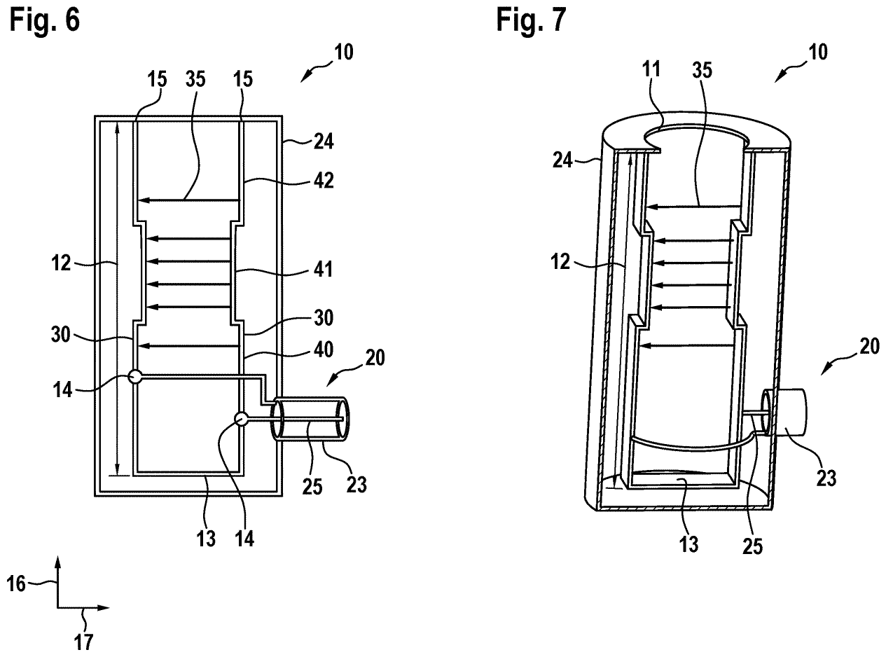

FIG. 6 shows a schematic cross sectional view and 3D model of a resonator in a cavity of an aerosol-generating device according to a fourth embodiment of the present invention,

FIG. 7 shows a further schematic cross sectional view and 3D model of the resonator in the cavity of the aerosol-generating device according to the fourth embodiment of the present invention,

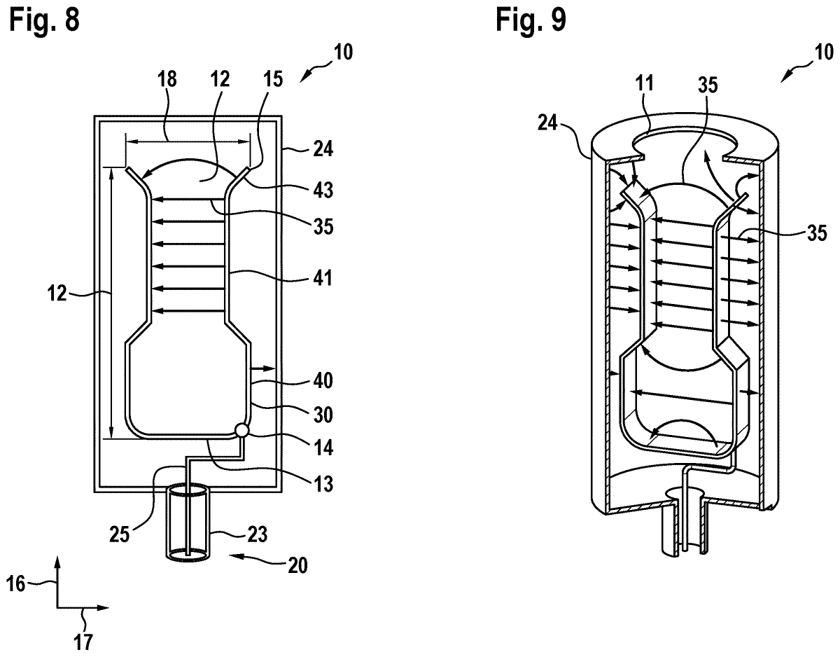

FIG. 8 shows a schematic cross sectional view and 3D model of a resonator in a cavity of an aerosol-generating device according to a fifth embodiment of the present invention,

FIG. 9 shows a further schematic cross sectional view and 3D model of the resonator in the cavity of the aerosol-generating device according to the fifth embodiment of the present invention,

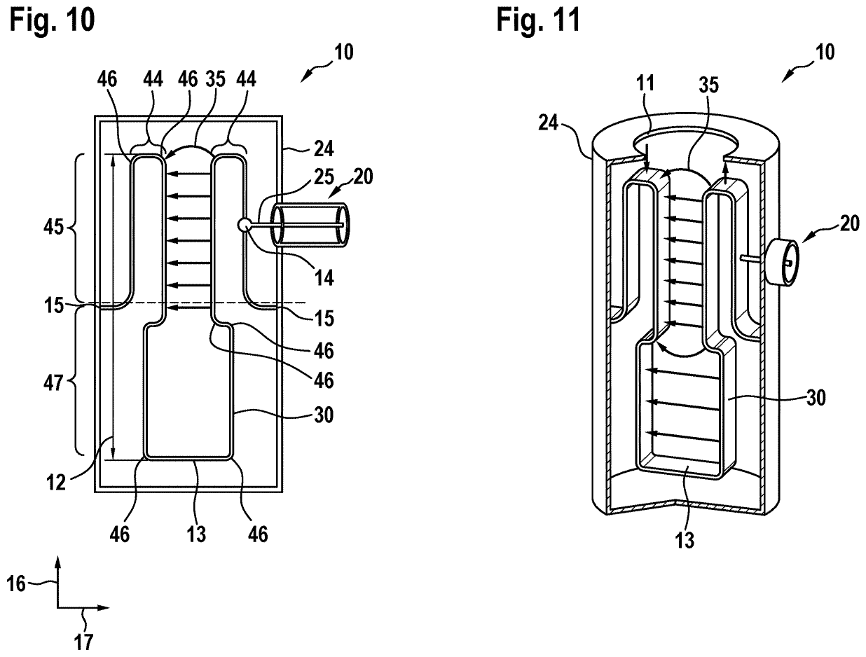

FIG. 10 shows a schematic cross sectional view and 3D model of a resonator in a cavity of an aerosol-generating device according to a sixth embodiment of the present invention,

FIG. 11 shows a further schematic cross sectional view and 3D model of the resonator in the cavity of the aerosol-generating device according to the sixth embodiment of the present invention,

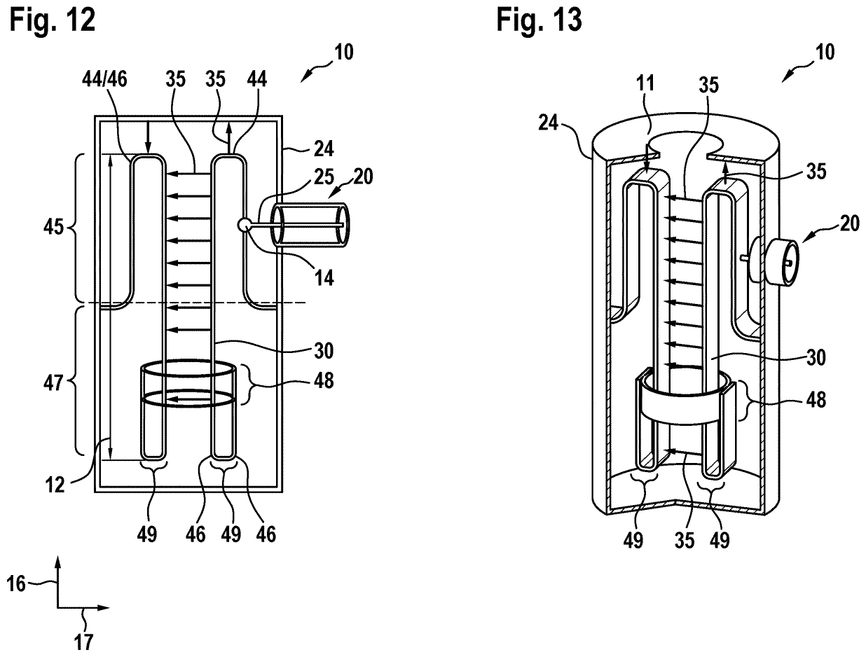

FIG. 12 shows a schematic cross sectional view and 3D model of a resonator in a cavity of an aerosol-generating device according to a seventh embodiment of the present invention,

FIG. 13 shows a further schematic cross sectional view and 3D model of the resonator in the cavity of the aerosol-generating device according to the seventh embodiment of the present invention,

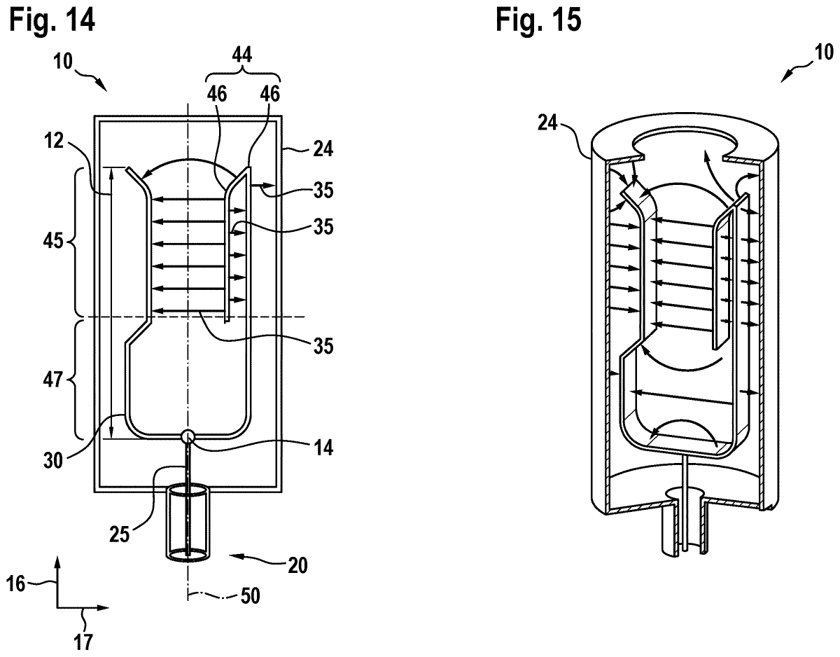

FIG. 14 shows a schematic cross sectional view and 3D model of a resonator in a cavity of an aerosol-generating device according to an eighth embodiment of the present invention,

FIG. 15 shows a further schematic cross sectional view and 3D model of the resonator in the cavity of the aerosol-generating device according to the eighth embodiment of the present invention,

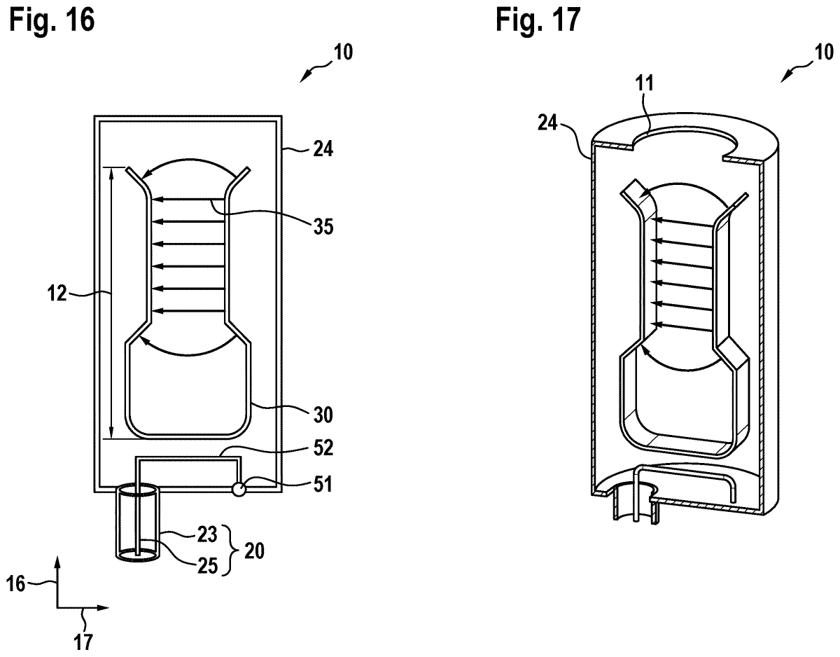

FIG. 16 shows a schematic cross sectional view and 3D model of a resonator inside a cavity of an aerosol-generating device according to a ninth embodiment of the present invention, and

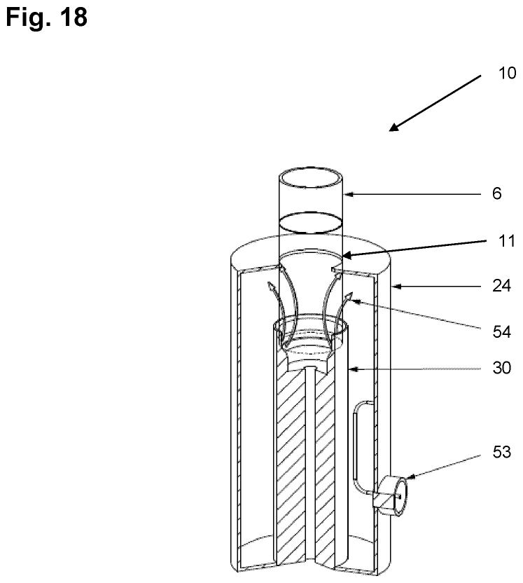

FIG. 17 shows a further schematic cross sectional view and 3D model of the resonator in the cavity of the aerosol-generating device according to the ninth embodiment of the present invention.

FIG. 18 shows a schematic cross section of a cavity resonator of an aerosol-generating device according to the tenth embodiment of the present invention.

FIG. 1 shows a schematic cross sectional view of an aerosol-generating device 1 (henceforth: “device 1”) according to a first embodiment of the present invention. In particular, FIG. 1 shows an overview of the device 1.

In the present embodiment, the device 1 is a handheld device. The device 1 is configured to generate an aerosol for consumption via inhalation by a consumer. The device 1 generates the aerosol by heating an aerosol-generating material 6 (henceforth: “material 6”). The aerosol-generating material (henceforth: “the material”) is a label used to mean a medium that generates an aerosol or vapour when heated. It may be synonymous with vapour precursor material, aerosol generation or generating medium, substrate or material. Aerosol generating material includes liquid or solid materials that provide volatilized components upon heating, typically in the form of vapour or an aerosol. Aerosol generating material may be a non-tobacco-containing material or a tobacco-containing material. Aerosol generating material may, for example, include one or more of tobacco per se, tobacco derivatives, expanded tobacco, reconstituted tobacco, tobacco extract, homogenized tobacco or tobacco substitutes. Aerosol precursor material also may include other, non-tobacco, products, which, depending on the product, may or may not contain nicotine. Aerosol generating material may comprise one or more humectants, such as glycerol or propylene glycol. In particular, the material 6 of the present embodiment as shown is a tobacco stick, containing a charge of reconstituted tobacco as aerosol-generating material.

The device 1 comprises an outer case 8, that is, for example, cylindrical, particularly tubular, in shape. Alternatively, the outer case 8 may be for example square-cylindrical.

The device 1 further comprises an electromagnetic field generating unit 4 (henceforth: “RF unit 4”) which is configured to generate a radio frequency (RF) signal. In the present embodiment, the RF signal is a microwave signal of, for example, between 2400 MHz and 2500 MHz. The embodiments are not limited to the RF unit 4 generating a microwave signal of between 2400 MHz and 2500 MHz For instance, the RF unit 4 may generate a RF signal above 500 MHz, which are commonly called microwaves, suitable for heating the material 6. The microwave signal is propagated to/through the material 6 (as will be described below) and thereby heats the material 6 so as to generate and release the aerosol therefrom.

The device 1 further comprises a battery module 2 electrically connected to the RF unit 4. The battery module 2 and the RF unit 4 are connected to a control module 3. The control module 3 is configured to control the RF unit 4 so as to generate an RF signal with suitable frequency and/or amplitude.

As can be taken from FIG. 1, the device 1 comprises a cavity 5 configured to contain a resonator 10. The resonator 10 receives the material 6, e.g., in the form of an aerosol generating (and releasing) material 6. The resonator 10 is connected to the RF unit 4 and is configured to propagate the RF signal therefrom to/through the material 6.

The device 1, especially an internal portion of the outer case 8, comprises at least one through-hole 9 for connecting the resonator 10 to the RF unit 4 such that the RF signal is propagated to/through the cavity 5 into the material 6. The number of through-holes 9 may correspond to a number of feeds 20, 21, 22, which will be discussed in the following.

In the following, embodiments of the device 1 describing the resonator 10 within the cavity 5 for heating the material 6 will be explained with reference to 3D models of the resonator 10. In other words, the following embodiments which show configurations and connection schemes of the resonator 10 may be advantageously combined with or included in the device 1 shown in FIG. 1. FIG. 2 shows a schematic cross sectional view of a resonator 10 in a cavity 5 of an aerosol-generating device 1 according to a second embodiment of the present invention. FIG. 3 shows a further schematic cross sectional view of the resonator 10 in the cavity 5 of the aerosol-generating device 1 according to the second embodiment of the present invention.

The resonator 10 of the present embodiment comprises a resonator casing 24. As can be taken especially from the perspective view of FIG. 3, the resonator casing 24 is substantially cylindrical, especially tubular, and comprises an opening 11 via which the material 6 (not shown here) is insertable into the resonator 10.

Furthermore, the resonator 10 of the present embodiment comprises two transmission lines 30. The transmission lines 30 are respectively connected to a feed 20. In particular, one transmission line 30 is connected to a first feed 21 and the other transmission line 30 is connected to a second feed 22. The feeds 21, 22 extend through the through-hole 9 shown in FIG. 1. Alternatively, the device 1 may comprise multiple through-holes 9, especially two through-holes 9, one for each feed 21, 22. As can be taken from the perspective view of FIG. 3, the transmission lines 30 respectively comprise elongated and bent plate shapes.

In the present embodiment, the feeds 21, 22 are coaxial cables each comprising a signal line 25 and a grounded shielding 23, which serves as a ground. The resonator casing 24 is connected to ground via the grounded shielding 23 of the feeds 21, 22.

As can be taken from FIGS. 2 and 3, the two transmission lines 30 are connected, especially integrally, to one another at a middle point 13. Even in the case of being integrally connected, these are defined as two transmission lines 30 due to their individual connection to the feeds 20, thereby acting as individual antennas.

A length 12 of each of the transmission lines 30 from a bottom thereof to respective end points 15 thereof along a substantial elongation direction 16 of the device 1 (compare also FIG. 1) is one-quarter of a wavelength of the generated RF signal from the RF unit 4. The length 12 is especially to be understood as an antenna length of each of the transmission lines 30.

In this regard, the length 12 of each of the transmission lines 30 is defined as not including a transversal connecting part thereof including the middle point 13. Said connecting part does not contribute significantly to the antenna effect of the transmission lines 30, especially with respect to electric field distribution 35 propagating between the transmission lines 30. The connecting part has the advantage of simplifying a fixation of the transmission lines 30 within the resonator casing 24. In particular, the two transmission lines 30 together with the connecting part may be easily manufactured by bending an elongated strip.

Further, each of the transmission lines 30 comprises, along the substantial elongation direction 16 of the device 1, a lower first portion 40 and an upper second portion 41. In particular, the upper second portion 41 is disposed, with respect to the substantial elongation direction 16, within at least an upper half, preferably at least in an upper quarter, of the resonator casing 24. Preferably, the lower first portion 40 is correspondingly disposed within at most in a lower half, preferably at most in a lower three-quarters, of the resonator casing 24.

Herein, the second portion 41 is tapered with respect to the first portion 40. For example, a width 18 of the second portion 41 is roughly 60% of the width 18 of the first portion 40. The width 18 is along a width direction 17 perpendicular to the elongation direction 16 and essentially describes a distance between the two transmission lines 30. This taper allows for the material 6 to be held by the transmission lines 30 and also has advantageous effects with regard to higher electric field intensity due to the reduced distance between the transmission lines 30. Further, by providing corresponding non-tapered first portions 40 of the transmission lines 30, air-flow for extraction of the generated aerosol is advantageously enhanced while simultaneously providing a strong hold of the material 6 and higher electric field intensity.

As denoted by the “+” and “−” symbols in FIG. 2, one transmission line 30 receives, from the respective signal line 25, the signal generated from the RF unit 4. Further, the respectively other transmission line 30 receives, from the respective other signal line 25, a negative generated RF signal, which is generated by phase-shifting the generated RF signal by 180°. In other words, the signal received by one transmission line 30 is phase-shifted by 180° with respect to the signal received by the other transmission line 30. The RF unit 4 preferably comprises a phase-shift circuit and/or active and/or passive components for phase-shifting the RF signal.

At the middle point 13, the phase-shifted signals will interfere destructively. Thereby, a short at the middle point is not physically realized and left floating, thereby resulting in a so-called virtual ground.

The end points 15 of the transmission lines 30 are not electrically (directly) connected to the grounded resonator casing 24. Thereby, a zero impedance of a ground plane is transformed to a so-called open with a high impedance. An effective length of the transmission lines 30 will depend on the dielectric characteristics of the material 6, since the material 6 capacitively couples the two transmission lines 30, which electrically elongates these.

A dominant field distribution of an RF field emitted by the transmission lines 30 is demonstrated via lines of force 35 (henceforth: “field distribution 35” or “electric field 35”). As demonstrated in FIGS. 2 and 3, the field distribution 35 achieved by the transmission lines 30 is advantageously uniform. Further, the transmission lines 30, as is apparent from a comparison of FIG. 1 with FIG. 2 or FIG. 3, are disposed around the material 6. In the present embodiment, the generated electric field 35 therefore propagates from one transmission line 30 through the material 6 into a portion of the other transmission line 30. Herein, the term “disposed around” means that the transmission lines 30 partially surround the inserted and received material 6, as a comparison of FIG. 3 with FIG. 1 shows. Further, the received material 6 is in contact with the tapered second portion 41, as described above. Therefore, in the illustrative example, the transmission lines 30 are partially in contact with said material 6. In the part where there is no direct contact, the material 6 is spaced apart from the first portion 40 of each transmission line 30, wherein the spacing between the material 6 and each transmission line 30 is preferably roughly 33% of the total width 18 of the material 6, i.e. of the width 18 of the second portion 41 (based on above example of 60% width 18 of second portion 41 with respect to first portion 40). Therefore, the first portion 40 of the transmission lines 30 is regarded as being in close proximity to the material 6, especially with no other elements therebetween.

FIG. 4 shows a schematic cross sectional view of a resonator 10 in a cavity 5 of an aerosol-generating device 1 according to a third embodiment of the present invention. FIG. 5 shows a further schematic cross sectional view of the resonator 10 in the cavity 5 of the aerosol-generating device 1 according to the third embodiment of the present invention.

In the present embodiment, the transmission lines 30 are additionally shorted, i.e. electrically connected, to the grounded resonator casing 24 at their end points 15. Further, the length 12 of the transmission lines 30 is respectively one-half of the wavelength of the generated RF signal from the RF unit 4.

Further, each transmission line 30 comprises the first portion 40, the second portion 41, as well as a third portion 42. The respective widths 18 of the first portion 40 and the third portion 42 are preferably roughly equal. The width 18 of the second portion 41 is preferably roughly 60% of the width 18 of the first portion 40 and the third portion 42. In the present embodiment, the transmission lines 30 are disposed around and partially in contact with the received material 6 at the second portion 41, and spaced apart therefrom at the first portion 40 and the third portion 42. Thereby, the length 12 of the transmission lines 30 is increased, which leads to a greater surface area of field distribution 35 and thus of heating of the material 6. With this, longer materials 6 may be (more evenly) heated.

FIG. 6 shows a schematic cross sectional view of a resonator 10 in a cavity 5 of an aerosol-generating device 1 according to a fourth embodiment of the present invention. FIG. 7 shows a further schematic cross sectional view of the resonator 10 in the cavity 5 of the aerosol-generating device 1 according to the fourth embodiment of the present invention.

In the present embodiment, both transmission lines 30 are connected to a single feed 20. Although in FIG. 6, for the sake of visibility and easy understanding, the connection points 14 are at different heights, these are provided at the same heights of the transmission lines 30, as is shown by the perspective view in FIG. 7.

Therein, the transmission lines 30 are connected to the signal line 25 and the grounded shielding 23 of the single feed 20, respectively. In particular, one transmission line 30 is connected to the signal line 25. The other transmission line 30 is connected to the grounded shielding 23 of the same single feed 20. Thereby, as also elucidated with regard to the second embodiment, a virtual ground is generated at their middle point 13.

Further, the transmission lines 30 are shorted, i.e. electrically connected, at their end points 15 to the resonator casing 24. The length 12 of the transmission lines 30 is one-half of the RF signal wavelength. Thereby, a similar field distribution 35 as with the third embodiment can be achieved with only one single feed 20.

The transmission lines 30 are, at their bottom plane of the middle point 13, not shorted to the resonator casing 24, as demonstrated in FIG. 6. In addition to being supported by their connection to the resonator casing 24 at their end points 15, these may be supported by insulating or dielectric material and/or struts within the resonator casing 24.

On the other hand, if the transmission lines 30 are not shorted at their end points 15 to the resonator casing 24, the length 12 of the transmission lines 30 can be reduced to one-quarter of the RF signal wavelength, as demonstrated in embodiment two.

FIG. 8 shows a schematic cross sectional view of a resonator 10 in a cavity 5 of an aerosol-generating device 1 according to a fifth embodiment of the present invention. FIG. 9 shows a further schematic cross sectional view of the resonator 10 in the cavity 5 of the aerosol-generating device 1 according to the fifth embodiment of the present invention.

In the present embodiment, the resonator 10 comprises one transmission line 30. Herein, the transmission line 30 is not shorted to the resonator casing 24 and thus comprises the length 12 of one-quarter of the wavelength of the RF signal.

Further, the transmission line 30 comprises an outwardly curved portion 43 respectively at its two end portions at the top thereof. Thereby, the width 18 at the end portion of the transmission line is roughly equal to the width 18 of the first portion 40.

In the present embodiment, the transmission line 30 is connected only to the signal line 25 of the single feed 20. Further, the resonator casing 24 is grounded via the grounded shielding 23 of the single feed 20. A virtual ground is generated at the middle point 13 of the transmission line 30.

The RF electric field 35 is generated between portions of the single transmission line 30, between which the material 6 (not shown) is inserted. Further, as demonstrated in FIG. 9, the electric field 35 also propagates from the transmission line 30 to the resonator casing 24. Possible electric losses caused thereby are, in the present case, advantageous, as these heat the resonator 10, thereby also heating the aerosol-generating material 6.

A position of the single feed 20 may be suitably altered. For instance, the single feed 20 may be positioned at a side of the resonator casing 24, as demonstrated in FIG. 7.

The transmission line 30 is disposed around the received material 6. In particular, the shown tapered second portion 41 is in contact with the received material 6, while the first portion 40 and the outwardly curved portion 43 are in close proximity to the received material 6, especially with no further elements therebetween.

FIG. 10 shows a schematic cross sectional view of a resonator 10 in a cavity 5 of an aerosol-generating device 1 according to a sixth embodiment of the present invention. FIG. 11 shows a further schematic cross sectional view of the resonator 10 in the cavity 5 of the aerosol-generating device 1 according to the sixth embodiment of the present invention.

In the present embodiment, one transmission line 30 with a length 12 of one-half wavelength is provided in the resonator 10. The transmission line 30 is connected only to the signal line 25 of the single feed 20. The resonator casing 24 is grounded via the grounded shielding 23 of the single feed 20.

Further, the end points 15 of the transmission line 30 are electrically connected to the resonator casing 24, and are thus also grounded. A virtual short sets in at the middle point 13 at the bottom of the transmission line 30. The electric field 35 of the RF signal is generated between portions of the transmission line 30, and, as shown in FIG. 11 between the transmission line 30 and the resonator casing 24.

Further, as shown, the transmission line 30 comprises two folded portions 44 in an upper portion 45 thereof. Each folded portion 44 refers to a portion of the transmission line 30 including two bends 46 of each 90° adjacent to one another. Preferably, the term “adjacent to one another” refers to these being respectively disposed within for example 10% of a total extension of the transmission line 30. Herein, the upper portion 45 refers to a portion of the transmission line 30 in an upper half of the resonator 10, with respect to a substantial elongation 16 of the device 1.

A lower portion 47 of the transmission line 30 in the lower half of the resonator 10 also comprises two bends 46 each of 90°. The bends 46 at the bottom (plane of middle point 13) of the lower portion 47 are defined as not adjacent to one another, in contrast to those of the upper portion 45 together defining one folded portion 44.

Advantageously, the effective length of the resonator 10 is reduced via the folded portions 44 and the bends 46. Further, the single feed 20 can therefore be introduced asymmetrically with respect to a length of the resonator casing 24 along the elongation direction 16.

Herein, the material 6 is inserted into the transmission line 30 between the two folded portions 44 in the upper portion 45 thereof. Thereby, the transmission line 30 is disposed around such received material 6. In particular, the transmission line 30 is in contact with the received material 6 at the upper portion 4 of the transmission line 30 and is spaced apart therefrom at the lower portion 47 of the transmission line 30.

FIG. 12 shows a schematic cross sectional view of a resonator 10 in a cavity 5 of an aerosol-generating device 1 according to a seventh embodiment of the present invention. FIG. 13 shows a further schematic cross sectional view of the resonator 10 in the cavity 5 of the aerosol-generating device 1 according to the seventh embodiment of the present invention.

Herein, similar to the sixth embodiment, the resonator 10 comprises one transmission line 30 with folded portions 44 in the upper portion 45 thereof. Therein, each of the folded portions 44 comprises a single bend 46, which is bent in a continuous half-circular shape, i.e. 180°.

Furthermore, the lower portion 47 of the transmission line 30 comprises two bottom folded portions 49, each comprising two adjacent bends 46 of 45°. As with the folded portions 44 of the upper portion 45, the bottom folded portions 49 of the lower portion 47 may also be formed each of a single 180° bend 46.

In addition, the transmission line 30 comprises a circular ring bent portion 48 in the lower portion 47 thereof. The ring bent portion 48 also causes a virtual ground. Thereby, as demonstrated in FIGS. 12 and 13, advantageous field distribution 35 is achieved. Further, the ring bent portion 48 advantageously accommodates and holds the material 6. Thereby, the transmission line 30 is disposed around and in contact with such received material 6.

FIG. 14 shows a schematic cross sectional view of a resonator 10 in a cavity 5 of an aerosol-generating device 1 according to an eighth embodiment of the present invention. FIG. 15 shows a further schematic cross sectional view of the resonator 10 in the cavity 5 of the aerosol-generating device 1 according to the eighth embodiment of the present invention.

The general configuration of the eighth embodiment is similar to that of the fifth embodiment.

Herein, the transmission line 30 is formed axial asymmetrically with regard to a longitudinal axis 50 of the resonator 10. Therein, the transmission line 30 includes a single folded portion 44 in the upper portion 45 thereof, which comprises two adjacent bends 46. A first bend 46 is less than 45° (i.e. bent more from straight state), whereas a second bend 46 is more than 45° (i.e. bent less from straight state), and these together constitute a 180° folded portion 44. For example, the first bend 46 may define an angle of roughly 30°, whereas the second bend 46 may define an angle of roughly 150°.

By forming the transmission line 30 axial asymmetrically with regard to the longitudinal axis 50, the feed 20 can be positioned axial symmetrically with regard to said axis 50. This simplifies a connection of the resonator 10 to the RF unit 4.

Herein, the material 6 is inserted into the transmission line 30 between the folded portion 44 and an opposing portion, with respect to the width direction 17, of the transmission line 30. Thereby, the transmission line 30 is disposed around the received material 6. Furthermore, as demonstrated by the taper of the upper portion 45, the transmission line 30 is in contact with and holds the received material 6 at the upper portion 45 of the transmission line 30. Further, the lower portion 47 of the transmission line 30 is disposed around and spaced apart from the received material 6. FIG. 16 shows a schematic cross sectional view of a resonator 10 in a cavity 5 of an aerosol-generating device 1 according to a ninth embodiment of the present invention. FIG. 17 shows a further schematic cross sectional view of the resonator 10 in the cavity 5 of the aerosol-generating device 1 according to the ninth embodiment of the present invention.

As can be taken from FIGS. 16 and 17, the general configuration of the ninth embodiment is similar to that of the fifth embodiment. As also described with regard to the fifth embodiment, the transmission line 30 is disposed around the received material 6. In particular, the shown tapered second portion 41 is in contact with the received material 6, while the first portion 40 and the outwardly curved portion 43 are in close proximity to the received material 6, especially with no further elements therebetween.

Herein, the transmission line 30 is not connected directly to the single feed 20. Instead, the signal line 25 is shorted to the resonator casing 24, which is grounded via the grounded shielding 23 of the single feed 20.

Thereby, a shorted loop 52 is formed, which induces a current in the transmission line 30. This induced current as well as a resulting voltage distribution along the resonator 10 is substantially similar to those of the previous embodiments.

Further, a position of a connection point 51 of the signal line 25 with the resonator casing 24 may be altered so as to be used as a matching element between the single feed 20 and the resonator 10.

FIG. 18 shows a schematic cross-sectional view of a resonator 10 in a cavity 5 of an aerosol-generating device 1 according to a tenth embodiment of the present invention. The resonator 10 comprises a resonator casing 24. The resonator casing 24 is substantially cylindrical and comprises an opening 11 via which an aerosol-generating material 6 is inserted into resonator 10. In an example, the material 6 may be in the form of a tobacco stick, as illustrated in the figure. The resonator 10 is configured to confine and resonate electromagnetic waves at an operating frequency that corresponds to the microwave frequency range suitable for heating the material, for example above 500 MHz, specifically between 2400 MHz and 2500 MHz.

The resonator 10 comprises a substantially cylindrical transmission line 30 and a magnetic loop 53. The transmission line 30 is energized by the magnetic loop 53. A magnetic loop 53 is an element that couples to the magnetic field component of an electromagnetic wave. The magnetic loop 53 is responsible for efficiently feeding the radiofrequency energy into the transmission line 30. The magnetic field distribution is shown by reference numeral 54. The transmission line 30 may have a length equal to a quarter of the wavelength of the operating frequency. This length combined with operation at microwave frequencies has the advantage of efficient energy transfer and impedance characteristics.

The aerosol-generating material 6 comprises one or more portions of aerosol-generating material. The one or more portions of the material 6 is inserted through an opening in the resonator casing 24 and into the transmission line 30. The one or more inserted portions of the aerosol-generating material 6 are heated by the cavity, thereby allowing for precise control over which portion of the material is heated. Specifically, the components of the cavity resonator are arranged such that the inserted portion of the material is predominantly affected by the magnetic field, with minimal exposure to the electric field, leading to targeted heating. The cavity resonator therefore has the advantage of having enhanced heating efficiency as well as allowing for selective heating of the material.

In addition to the foregoing written explanations, it is explicitly referred to FIGS. 1 to 18, wherein the figures in detail show configuration examples of the invention.

### LIST OF REFERENCE NUMERALS

1 aerosol-generating device
2 battery module
3 control module
4 electromagnetic field generating unit
5 cavity
6 aerosol-generating material
8 outer case
9 through-hole
10 resonator
11 opening
12 length of transmission line
13 middle point
14 connection point
15 end point
16 elongation direction of device
17 width direction
18 width
20 feed
21 feed
22 feed
23 grounded shielding
24 resonator casing
25 signal line
30 transmission line
35 electric field force lines/field distribution
40 first portion
41 second portion
42 third portion
43 curved portion
44 folded portion
45 upper portion
46 bend
47 lower portion
48 ring bent portion
49 bottom folded portion
50 longitudinal axis
51 connection point
52 shorted loop
53 magnetic loop
54 magnetic field lines

1.-16. (canceled)

17. An aerosol-generating device configured to generate aerosol by heating an aerosol-generating material, the aerosol-generating device comprising:
a cavity configured to receive the aerosol-generating material;
an electromagnetic field generating unit configured to generate a signal; and
a resonator disposed in the cavity and electrically connected, via at least one feed, to the electromagnetic field generating unit,
wherein the resonator comprises:
a first transmission line and a second transmission line, the first and the second transmission lines being configured to receive the generated signal and to generate an electromagnetic field configured to heat the aerosol-generating material, and
a resonator casing that at least partially surrounds the first and the second transmission lines, and
wherein each of the first and the second transmission lines includes a first portion and a second portion, a distance between the second portions of the first and the second transmission lines being narrower than a distance between the first portions of the first and the second transmission lines, the at least one feed being arranged at the first portion.

18. The aerosol-generating device according to claim 17, wherein the first and the second transmission lines are disposed around and in close proximity of the received aerosol-generating material.

19. The aerosol-generating device according to claim 18, wherein the first and the second transmission lines are at least partially in contact with the received aerosol-generating material.

20. The aerosol-generating device according to claim 17,
wherein the first transmission line is electrically connected to a signal line of a first feed of the at least one feed and the second transmission line is electrically connected to a signal line of a second feed of the at least one feed, and
wherein the signal line of the first feed supplies the generated signal to the first transmission line and the signal line of the second feed supplies a negative generated signal, which is the generated signal phase-shifted by 180°, to the second transmission line.

21. The aerosol-generating device according to claim 17,
wherein the at least one feed comprises one single feed,
wherein the first and the second transmission lines are electrically connected to the single feed,
wherein the first transmission line is connected to a signal line of the single feed and receives the generated signal, and
wherein the second transmission line is connected to a ground of the single feed.

22. The aerosol-generating device according to claim 17, wherein the first and the second transmission lines each comprise a length of one-quarter or one-half of a wavelength of the generated signal.

23. The aerosol-generating device according to claim 22,
wherein the first and the second transmission lines each further comprise a length of one-half wavelength, and
wherein the first and the second transmission lines are electrically connected to the resonator casing.

24. The aerosol-generating device according to claim 17, wherein at least one end of each of the first and the second transmission lines is electrically connected to the resonator casing.

25. The aerosol-generating device according to claim 17.
wherein the resonator casing contains an opening configured to receive the aerosol-generating material, and
wherein the first and the second transmission lines are configured to accommodate the aerosol-generating material.

26. The aerosol-generating device according to claim 17, wherein the aerosol-generating device is a handheld device.
